(19) United States
(12) Patent Application Publication
(10) Pub. No.: US 2024/0340849 A1
(43) Pub. Date: Oct. 10, 2024

(54) METHODS AND APPARATUS FOR HANDLING NON-3GPP SLICE REGISTRATION IN A WIRELESS COMMUNICATION SYSTEM

(71) Applicant: Samsung Electronics Co., Ltd., Gyeonggi-do (KR)

(72) Inventors: Lalith KUMAR, Bengaluru (IN); Danish Ehsan Hashmi, Bengaluru (IN); Jagadeesh Gandikota, Bengaluru (IN); Koustav Roy, Bengaluru (IN); Ashok Kumar Nayak, Bengaluru (IN)

(21) Appl. No.: 18/630,112

(22) Filed: Apr. 9, 2024

(30) Foreign Application Priority Data
Apr. 10, 2023 (IN) 202341026620
Apr. 15, 2023 (IN) 202341027802
Mar. 21, 2024 (IN) 202341026620

(51) Int. Cl. H04W 68/00; H04W 48/02

(52) U.S. Cl. CPC H04W 68/00; H04W 48/02

(57) ABSTRACT

Methods and systems are provided for handling non-3rd generation partnership project (3GPP) slice registration in 3GPP networks. A protocol data unit (PDU) session is managed in a wireless communication network in which a user equipment (UE) determines the allowed PDU session which can be transferred from non-3GPP access to 3GPP access. Paging resources are managed in a wireless communication network in which an access and mobility management function (AMF) checks if the data to be sent on the PDU session of non-3GPP access is of single-network slice selection assistance information (S-NSSAI) which is in an allowed network slice selection assistance information (NSSAI) list of 3GPP access.

### CROSS REFERENCE TO RELATED APPLICATION

This application is based on and derives the benefit of Indian Provisional Application Nos. 20/234,1026620 and 202341027802, filed in the Indian Patent Office on Apr. 10, 2023, and Apr. 15, 2023, respectively, and Indian Non-Provisional application Ser. No. 20/234,1026620, filed in the Indian Patent Office on Mar. 21, 2024, the entire contents of which are incorporated herein by reference.

### BACKGROUND

### 1. Field

Embodiments disclosed herein relate generally to wireless communication networks, and more particularly, to the handling of non-3^{rd} Generation Partnership Project (N3GPP) slice registration in wireless communication networks.

### 2. Description of Related Art

5G mobile communication technologies define broad frequency bands such that high transmission rates and new services are possible, and can be implemented not only in “Sub 6 GHz” bands such as 3.5 GHz, but also in “Above 6 GHz” bands referred to as mm Wave including 28 GHz and 39 GHz. In addition, it has been considered to implement 6G mobile communication technologies (referred to as Beyond 5G systems) in terahertz bands (for example, 95 GHz to 3THz bands) in order to accomplish transmission rates fifty times faster than 5G mobile communication technologies and ultra-low latencies one-tenth of 5G mobile communication technologies.

At the beginning of the development of 5G mobile communication technologies, in order to support services and to satisfy performance requirements in connection with enhanced Mobile BroadBand (eMBB), Ultra Reliable Low Latency Communications (URLLC), and massive Machine-Type Communications (mMTC), there has been ongoing standardization regarding beamforming and massive MIMO for mitigating radio-wave path loss and increasing radio-wave transmission distances in mmWave, supporting numerologies (for example, operating multiple subcarrier spacings) for efficiently utilizing mmWave resources and dynamic operation of slot formats, initial access technologies for supporting multi-beam transmission and broadbands, definition and operation of BWP (BandWidth Part), new channel coding methods such as a LDPC (Low Density Parity Check) code for large amount of data transmission and a polar code for highly reliable transmission of control information, L2 pre-processing, and network slicing for providing a dedicated network specialized to a specific service.

Currently, there are ongoing discussions regarding improvement and performance enhancement of initial 5G mobile communication technologies in view of services to be supported by 5G mobile communication technologies, and there has been physical layer standardization regarding technologies such as V2X (Vehicle-to-everything) for aiding driving determination by autonomous vehicles based on information regarding positions and states of vehicles transmitted by the vehicles and for enhancing user convenience, NR-U (New Radio Unlicensed) aimed at system operations conforming to various regulation-related requirements in unlicensed bands, NR UE Power Saving, Non-Terrestrial Network (NTN) which is UE-satellite direct communication for providing coverage in an area in which communication with terrestrial networks is unavailable, and positioning.

Moreover, there has been ongoing standardization in air interface architecture/protocol regarding technologies such as Industrial Internet of Things (IIoT) for supporting new services through interworking and convergence with other industries, IAB (Integrated Access and Backhaul) for providing a node for network service area expansion by supporting a wireless backhaul link and an access link in an integrated manner, mobility enhancement including conditional handover and DAPS (Dual Active Protocol Stack) handover, and two-step random access for simplifying random access procedures (2-step RACH for NR). There also has been ongoing standardization in system architecture/service regarding a 5G baseline architecture (for example, service based architecture or service based interface) for combining Network Functions Virtualization (NFV) and Software-Defined Networking (SDN) technologies, and Mobile Edge Computing (MEC) for receiving services based on UE positions.

As 5G mobile communication systems are commercialized, connected devices that have been exponentially increasing will be connected to communication networks, and it is accordingly expected that enhanced functions and performances of 5G mobile communication systems and integrated operations of connected devices will be necessary. To this end, new research is scheduled in connection with eXtended Reality (XR) for efficiently supporting AR (Augmented Reality), VR (Virtual Reality), MR (Mixed Reality) and the like, 5G performance improvement and complexity reduction by utilizing Artificial Intelligence (AI) and Machine Learning (ML), AI service support, metaverse service support, and drone communication.

Furthermore, such development of 5G mobile communication systems will serve as a basis for developing not only new waveforms for providing coverage in terahertz bands of 6G mobile communication technologies, multi-antenna transmission technologies such as Full Dimensional MIMO (FD-MIMO), array antennas and large-scale antennas, metamaterial-based lenses and antennas for improving coverage of terahertz band signals, high-dimensional space multiplexing technology using OAM (Orbital Angular Momentum), and RIS (Reconfigurable Intelligent Surface), but also full-duplex technology for increasing frequency efficiency of 6G mobile communication technologies and improving system networks, AI-based communication technology for implementing system optimization by utilizing satellites and AI (Artificial Intelligence) from the design stage and internalizing end-to-end AI support functions, and next-generation distributed computing technology for implementing services at levels of complexity exceeding the limit of UE operation capability by utilizing ultra-high-performance communication and computing resources.

5th generation (5G) or new radio (NR) mobile communications is recently gathering increased momentum with all the worldwide technical activities on the various candidate technologies from industry and academia. The candidate enablers for the 5G/NR mobile communications include massive antenna technologies, from legacy cellular frequency bands up to high frequencies, to provide beamforming gain and support increased capacity, new waveform (e.g., a new radio access technology (RAT)) to flexibly accommodate various services/applications with different requirements, new multiple access schemes to support massive connections, and so on.

In a particular scenario, as shown in FIG. 1, a user equipment (UE) may establish a protocol data unit (PDU) session over a network slice (e.g., single-network slice selection assistance information (S-NSSAI) over non-3GPP access (n3GPPA)) and may go out of service in a N3GPP network (i.e., in a 5G mobility management (5GMM)_IDLE state over n3GPPA). The network may then send paging to the UE over 3GPP access (3GPPA), if the network has downlink (DL) data in one of the active PDU sessions of n3GPPA. The paging message may have an indication indicating the n3GPPA type.

The UE may be expected to respond to this paging message with a service request procedure and include the allowed PDU session status information element (IE) (i.e., if the paging request includes an indication for n3GPPA type). The allowed PDU session status IE may be included in a service request message. If the UE has established the PDU session(s) associated with the S-NSSAI(s) which are included in the allowed NSSAI for 3GPP access, the UE may indicate the PDU session(s) for which the UE allows the user-plane resources to be re-established over 3GPP access in the allowed PDU session status IE. Otherwise, the UE may not indicate any PDU session(s) in the allowed PDU session status IE.

In this scenario, if the particular network slice (i.e., S-NSSAI-A) is not in the allowed list of 3GPPA type for the network, the UE may not establish the PDU session with S-NSSAI-A. This may cause a wastage of paging resources from the network side as the DL data may never reach to network over 3GPPA type.

For example, if the network has pending data for a UE on PDU session ID-1 of n3GPPA and the UE is in an idle mode over n3GPPA, then the network may attempt to move the PDU session to 3GPPA. Thus, the network may page the UE with access type of n3GPPA on 3GPPA. If the UE policy allows movement of such PDU sessions from n3GPPA to 3GPPA, then the UE may indicate the n3GPPA PDU session in an allowed PDU session status IE over 3GPPA. The network may move such PDU sessions to 3GPPA. However, after moving to 3GPPA, such PDU sessions may not be usable in certain scenarios, because the UE on 3GPPA is in the area where S-NSSAI is not supported. Thus, the entire procedure which has already been executed, involves a lot of message exchanges in the core network, and involves interactions with UE, may not be beneficial. Further, though the PDU sessions are moved to 3GPP access, the UE may again find the signal on n3GPPA and end up moving those PDU sessions to n3GPPA. Thus, the handover of a PDU session from one access to another may not be beneficial and the data may not be transferred or received from the network.

If the network has pending data for a UE on PDU session ID-1 of n3GPPA and the UE is in an IDLE mode over n3GPPA, then the network may attempt to move the PDU session to 3GPPA. Thus, the network may page the UE with an access type of n3GPPA over 3GPPA. As per the prior art, if the UE policy allows movement of such PDU sessions from n3GPPA to 3GPPA, then the UE may indicate the n3GPPA PDU session in allowed PDU session status IE over 3GPPA. However, those PDU sessions may not be part of an allowed NSSAI list over 3GPPA (wherein the allowed NSSAI list is different for 3GPP access and non-3GPP access). Thus, paging the UE using the broadcast channel (which is very costly) may not be beneficial.

The allowed NSSAI list is set forth below:
A. 3GPPA: S-NSSAI-B
B. N3GPPA: S-NSSAI-A, S-NSSAI-B

As shown in FIG. 1, at step 1, a PDU Session-A is established over n3GPPA having S-NSSAI-A. At step 2, the UE goes to an 5GMM_IDLE state over N3GPPA type. At step 3, the network (NW) has DL data to send for PDU session-A of S-NSSAI-A. At step 4, the NW sends paging with a n3GPPA type indication or a notification message over 3GPPA with n3GPPA type indication. At step 5, the UE checks if S-NSSAI-A is not in the allowed list over 3GPPA. The UE will not indicate PDU session-A in the allowed PDU session status IE. At step 6, the service request message is sent to the network (i.e., an access and mobility management function (AMF)) with the allowed PDU session status IE. At step 7, the network checks if the PDU session-A is not available in the allowed PDU session status IE, and hence, the establishment will fail for PDU session-A over 3GPPA. The pending DL data will then be dropped.

### SUMMARY

Embodiments describe methods and systems for handling n3GPP slice registration in 3GPP networks.

Embodiments also describe methods and systems for managing a PDU session in a wireless communication network, where the UE determines the allowed PDU session that can be transferred from n3GPPA to 3GPPA.

Additionally, embodiments describe methods and systems for managing paging resources in a wireless communication network, where an AMF checks if the data to be sent on the PDU session of n3GPPA access is of an S-NSSAI which is in an allowed NSSAI list of 3GPP access.

Further, embodiments describe methods and systems for handling n3GPP slice registration in 3GPP networks, when paging is not allowed over an access type having no allowed slice(s). Embodiments also describe methods and systems for handling n3GPP slice registration in 3GPP networks, when paging with a n3GPPA type indication is received.

Accordingly, embodiments describe a method performed by a terminal in a wireless communication system, the method comprising: receiving, a paging message with an access type indicating non-third generation partnership (3GPP) access; identifying whether the terminal has at least one protocol data unit (PDU) session associated with the non-3GPP access for which single network slice selection assistance information (S-NSSAI) associated with the at least one PDU session is included in partially allowed network slice selection assistance information (NSSAI) for 3GPP access; and in case that the terminal has the at least one PDU session associated with the non-3GPP access for which the S-NSSAI associated with the at least one PDU session is included in the partially allowed NSSAI for the 3GPP access, transmitting, to an access and mobility management function (AMF), information indicating the at least one PDU session for which the terminal allows user-plane resources to be re-established over the 3GPP access.

Accordingly, the method further comprising: in case that the terminal has the at least one PDU session associated with the non-3GPP access for which the S-NSSAI associated with the at least one PDU session is not included in the partially allowed NSSAI for the 3GPP access, determining not transmitting, to the AMF, the information indicating the at least one PDU session for which the terminal allows user-plane resources to be re-established over the 3GPP access.

Accordingly, wherein the transmitting, to the AMF, the information indicating the at least one PDU session for which the terminal allows the user-plane resources to be re-established over the 3GPP access comprises:
identifying whether a tracking area identity (TAI) where the terminal is currently camped is in a list of a tracking area (TA) for which the S-NSSAI is allowed; and
in case that the terminal has the at least one PDU session associated with the non-3GPP access for which the S-NSSAI associated with the at least one PDU session is included in the partially allowed NSSAI for the 3GPP access and the TAI where the terminal is currently camped is in the list of the TA for which the S-NSSAI is allowed, transmitting, to the AMF, the information indicating the at least one PDU session for which the terminal allows user-plane resources to be re-established over the 3GPP access.

Accordingly, wherein the information is included in an allowed PDU session status information element of a registration request message or a service request message.

Accordingly, embodiments describe a method performed by an access and mobility management function (AMF) in a wireless communication system, the method comprising: identifying whether at least one protocol data unit (PDU) session associated with the non-3GPP access for which single network slice selection assistance information (S-NSSAI) associated with the at least one PDU session is included in allowed network slice selection assistance information (NSSAI) for 3GPP access; and in case that the at least one PDU session associated with the non-3GPP access for which the S-NSSAI associated with the at least one PDU session is not included in the allowed NSSAI for the 3GPP access, transmitting, to a network function (NF), a message indicating that a terminal is not reachable.

Accordingly, embodiments describe a terminal in a wireless communication system, the terminal comprising: a transceiver; and at least one processor coupled with the transceiver and configured to: receive, a paging message with an access type indicating non-third generation partnership (3GPP) access, identify whether the terminal has at least one protocol data unit (PDU) session associated with the non-3GPP access for which single network slice selection assistance information (S-NSSAI) associated with the at least one PDU session is included in partially allowed network slice selection assistance information (NSSAI) for 3GPP access, and in case that the terminal has the at least one PDU session associated with the non-3GPP access for which the S-NSSAI associated with the at least one PDU session is included in the partially allowed NSSAI for the 3GPP access, transmit, to an access and mobility management function (AMF), information indicating the at least one PDU session for which the terminal allows user-plane resources to be re-established over the 3GPP access.

Accordingly, embodiments describe an access and mobility management function (AMF) in a wireless communication system, the AMF comprising: a transceiver; and at least one processor coupled with the transceiver and configured to: identify whether at least one protocol data unit (PDU) session associated with the non-3GPP access for which single network slice selection assistance information (S-NSSAI) associated with the at least one PDU session is included in allowed network slice selection assistance information (NSSAI) for 3GPP access, and in case that the at least one PDU session associated with the non-3GPP access for which the S-NSSAI associated with the at least one PDU session is not included in the allowed NSSAI for the 3GPP access, transmit, to a network function (NF), a message indicating that a terminal is not reachable.

Accordingly, embodiments describe a method for managing a PDU session in a wireless communication network. A UE receives a paging message with a n3GPPA type indication over 3GPPA. The UE determines if S-NSSAI of at least one PDU session of the n3GPPA is supported in a current UE camped area over the 3GPPA, if the UE has at least one PDU session with n3GPPA. The UE indicates the at least one PDU session for which the UE is allowed to re-establish user-plane resources over 3GPPA in an allowed PDU session status IE to the network, on determining the S-NSSAI of at least one PDU session of the n3GPPA is supported in a current UE camped area over the 3GPPA.

Accordingly, embodiments provide a UE including a processor, a memory, and at least one communication module. The processor is coupled with the memory and the at least one communication module. The processor receives a paging message with n3GPPA type indication over 3GPPA, and determines if S-NSSAI of at least one PDU session of the n3GPPA is supported in a current UE camped area over the 3GPPA, if the UE has at least one PDU session with n3GPPA. The processor can further indicate the at least one PDU session for which the UE is allowed to re-establish user-plane resources over 3GPPA in an allowed PDU session status IE to the network, on determining the S-NSSAI of at least one PDU session of the n3GPPA is supported in a current UE camped area over the 3GPPA.

Accordingly, the embodiments provide a method for managing paging resources in a wireless communication network. The method comprises a network function (NF) checking if S-NSSAI of a PDU session for which there is pending downlink data is in the NSSAI list, and paging to a UE with n3GPPA type, if the S-NSSAI of the PDU session for which there is pending downlink data is in the NSSAI list. Consider that the UE is in an idle state over n3GPPA, and DL data is pending over the PDU session of n3GPPA type. The method can further indicate to a second NF that the UE is not reachable, if the S-NSSAI of the PDU session for which there is pending downlink data is not in the NSSAI list.

Accordingly, the embodiments provide an NF in a wireless communication network, where the NF includes a processor, a memory, and at least one communication module. The processor can be coupled with the memory and the at least one communication module. The processor can check if S-NSSAI of a PDU session for which there is pending downlink data in the NSSAI list, and page to a UE with n3GPPA type, if the S-NSSAI of the PDU session for which there is pending downlink data in the NSSAI list. The UE is in an idle state over n3GPPA, and DL data is pending over the PDU session of n3GPPA type. The processor can further indicate to a second NF that the UE is not reachable if the S-NSSAI of the PDU session for which there is pending downlink data is not in the NSSAI list.

These and other aspects of the embodiments herein will be better appreciated and understood when considered in conjunction with the following description and the accompanying drawings. It should be understood, however, that the following descriptions, while indicating at least one embodiment and numerous specific details thereof, are given by way of illustration and not of limitation. Many changes and modifications may be made within the scope of the embodiments herein without departing from the spirit thereof, and the embodiments herein include all such modifications.

### BRIEF DESCRIPTION OF THE DRAWINGS

Embodiments herein are illustrated in the accompanying drawings, throughout which like reference letters indicate corresponding parts in the various figures. The embodiments herein will be better understood from the following description with reference to the following drawings. Embodiments herein are illustrated by way of examples in the accompanying drawings, and in which:

FIG. 1 is a diagram in which a UE receives paging for not allowed S-NSSAI in particular access;

FIG. 2 is a diagram illustrating a wireless communication network, according to an embodiment;

FIG. 3 is a diagram illustrating a UE, according to an embodiment;

FIG. 4 is a diagram illustrating an NF, according to an embodiment;

FIG. 5 is a flowchart illustrating a process of managing a PDU session in a wireless communication network, according to an embodiment;

FIG. 6 is a flowchart illustrating a process of managing paging resources in a wireless communication network, according to an embodiment;

FIG. 7 is a flow diagram illustrating a process for handling n3GPP slice registration in 3GPP networks, when paging is not allowed over access type having no allowed slice(s), according to an embodiment;

FIG. 8 is a flow diagram illustrating a process for handling n3GPP slice registration in 3GPP networks, when paging with n3GPPA type indication is received, according to an embodiment; and

FIG. 9 is a flow diagram illustrating a process of establishing user plane resources over the 3GPPA, according to an embodiment.

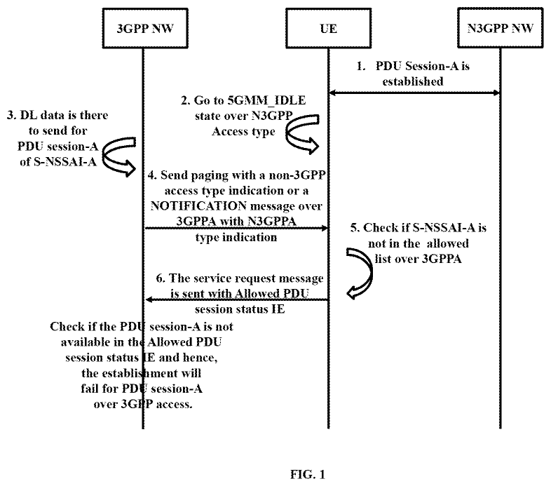

### DETAILED DESCRIPTION

The embodiments herein and the various features and advantageous details thereof are explained more fully with reference to the non-limiting embodiments that are illustrated in the accompanying drawings and detailed in the following description. Descriptions of well-known components and processing techniques are omitted so as to not to unnecessarily obscure the embodiments herein. The examples used herein are intended merely to facilitate an understanding of ways in which the embodiments herein may be practiced and to further enable those of skill in the art to practice the embodiments herein. Accordingly, the examples should not be construed as limiting the scope of the embodiments herein.

For the purposes of interpreting this specification, the definitions (as defined herein) will apply and whenever appropriate the terms used in singular will also include the plural and vice versa. It is to be understood that the terminology used herein is for the purposes of describing particular embodiments only and is not intended to be limiting. The terms “comprising”, “having” and “including” are to be construed as open-ended terms unless otherwise noted.

The words/phrases “exemplary”, “example”, “illustration”, “in an instance”, “and the like”, “and so on”, “etc.”, “etcetera”, “e.g.,”, “i.e.,” are merely used herein to mean “serving as an example, instance, or illustration.” Any embodiment or implementation of the present subject matter described herein using the words/phrases “exemplary”, “example”, “illustration”, “in an instance”, “and the like”, “and so on”, “etc.”, “etcetera”, “e.g.,”, “i.e.,” is not necessarily to be construed as preferred or advantageous over other embodiments.

Embodiments herein may be described and illustrated in terms of blocks which carry out a described function or functions. These blocks, which may be referred to herein as managers, units, modules, hardware components or the like, are physically implemented by analog and/or digital circuits such as logic gates, integrated circuits, microprocessors, microcontrollers, memory circuits, passive electronic components, active electronic components, optical components, hardwired circuits and the like, and may optionally be driven by a firmware. The circuits may, for example, be embodied in one or more semiconductor chips, or on substrate supports such as printed circuit boards and the like. The circuits constituting a block may be implemented by dedicated hardware, or by a processor (e.g., one or more programmed microprocessors and associated circuitry), or by a combination of dedicated hardware to perform some functions of the block and a processor to perform other functions of the block. Each block of the embodiments may be physically separated into two or more interacting and discrete blocks without departing from the scope of the disclosure. Likewise, the blocks of the embodiments may be physically combined into more complex blocks without departing from the scope of the disclosure.

Elements in the drawings are illustrated for the purposes of this description and case of understanding and may not have necessarily been drawn to scale. For example, the flowcharts/sequence diagrams illustrate the method in terms of the steps required for understanding of aspects of the embodiments as disclosed herein. Furthermore, in terms of the construction of the device, one or more components of the device may have been represented in the drawings by conventional symbols, and the drawings may show only those specific details that are pertinent to understanding the present embodiments so as not to obscure the drawings with details that will be readily apparent to those of ordinary skill in the art having the benefit of the description herein. Furthermore, in terms of the system, one or more components/modules which comprise the system may have been represented in the drawings by conventional symbols, and the drawings may show only those specific details that are pertinent to understanding the present embodiments so as not to obscure the drawings with details that will be readily apparent to those of ordinary skill in the art having the benefit of the description herein.

The accompanying drawings are used to help easily understand various technical features and the embodiments presented herein are not limited by the accompanying drawings. As such, the present disclosure should be construed to extend to any modifications, equivalents, and substitutes in addition to those which are particularly set out in the accompanying drawings and the corresponding description.

Usage of words such as first, second, third etc., to describe components/elements/steps is for the purposes of this description and should not be construed as sequential ordering/placement/occurrence unless specified otherwise.

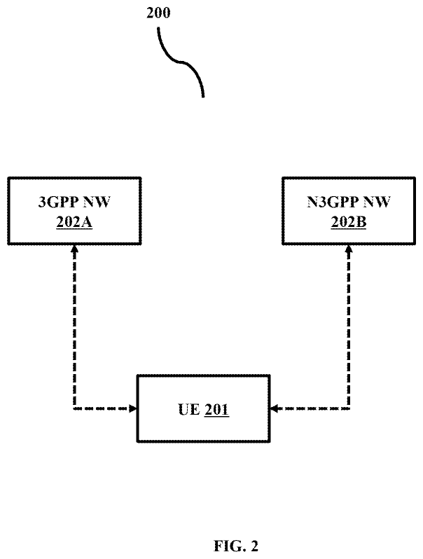

The embodiments herein achieve methods and systems for handling n3GPP slice registration in 3GPP networks. Referring to the drawings, and more particularly to FIGS. 2 through 9, where similar reference characters denote corresponding features consistently throughout the figures, there are shown embodiments.

The following abbreviations and definitions are referred to herein:
AMF: Access and Mobility Management Function
NSAC: Network Slice Admission Control
NSACF: Network Slice Admission Control Function
NSI ID: Network Slice Instance Identifier
NSSAA: Network Slice-Specific Authentication and Authorization
NSSAAF: Network Slice-specific and SNPN Authentication and Authorization Function
NSSAI: Network Slice Selection Assistance Information
NSSF: Network Slice Selection Function
NSSP: Network Slice Selection Policy
NSSRG: Network Slice Simultaneous Registration Group

Embodiments describe the behavior of a UE when partially allowed NSSAI or network slice-area of service (NS-AOS) features are applicable. When paging with n3GPP access type is received, a UE checks first on a 3GPPa current camped tracking area identity (TAI) and cell. If the current camped TAI and/or cell support the S-NSSAI based on a partially allowed NSSAI and NS_AOS information, only those PDU sessions (of n3GPPA type) are indicated/included in an allowed PDU session status IE. The network does not transfer the PDU sessions to 3GPP access which are not supported in the current camped location (TAI/cell) of the UE.

Embodiments describe the behavior of a network (for e.g., AMF), which is applicable for slicing feature(s). When data/signaling is pending for a PDU session belonging to n3GPPA, and if the UE is in idle state, the network pages the UE with n3GPPA type. Before paging the UE, the network checks if the S-NSSAI (belonging to the PDU session for pending data) is part of the allowed NSSAI list. If the S-NSSAI (belonging to the PDU session for pending data) is part of the allowed NSSAI list, the network can page the UE. If the S-NSSAI (belonging to the PDU session for pending data) is not a part of the allowed NSSAI list, the network may not page the UE and inform the SMF that the UE is not reachable.

FIG. 2 is a diagram illustrating a wireless communication network, according to an embodiment. A wireless communication network 200, as depicted, includes at least one UE 201, and at least one public land mobile network (PLMN) 202. The PLMN 202 may be a 3GPP network 202A with 3GPPA. The PLMN 202 may be a n3GPP network 202B with n3GPPA. The PLMN 202 may include one or more entities, such as, but not limited to, an AMF, a session management function (SMF), or any other NF. Embodiments herein use the terms ‘PLMN’, ‘network’, ‘NW’, ‘network function’, ‘NF’ interchangeably to refer to the PLMN 202A, 202B. Embodiments herein are explained using the AMF as an example of a NF; however, it may be obvious to a person of ordinary skill in the art that any other NF in the PLMNs 202A, 202B may perform the tasks disclosed as being performed by the AMF.

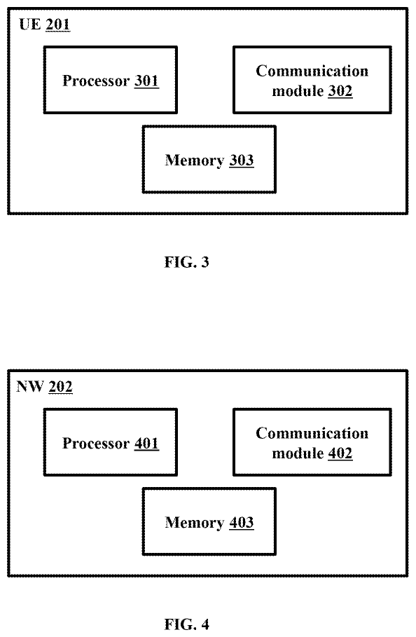

FIG. 3 is a diagram illustrating a UE, according to an embodiment. A UE 201 may include a processor 301, at least one communication module 302, and a memory 303. The UE 201 may manage a PDU session in a wireless communication network. The processor 301 may receive a paging message with n3GPPA type indication over 3GPPA.

The UE 201 may have at least one PDU session with n3GPPA. Upon receiving the paging message, the processor 301 may determine if a S-NSSAI of at least one PDU session of the n3GPPA is supported in a current UE camped area over the 3GPPA. The processor 301 may determine that the S-NSSAI of at least one PDU session of the n3GPPA is supported in the current UE camped area over the 3GPPA based on partially allowed NSSAI and NS-AoS information. The S-NSSAI of the at least one PDU session of the n3GPPA supported in the current UE camped arca over the 3GPPA may be included by the processor 301 in a partially allowed NSSAI for 3GPPA, and a TAI where the UE 201 is currently camped is in the list of TAs for which the S-NSSAI is supported. The S-NSSAI of at least one PDU session of the non-3GPPA supported in the current UE camped area over the 3GPPA may be included by the processor 301 in NS-AoS for 3GPPA, and the serving cell is in the list of cells for which the S-NSSAI is available.

If the S-NSSAI of at least one PDU session of the n3GPPA is supported in a current UE camped area over the 3GPPA, the processor 301 may indicate the at least one PDU session for which the UE is allowed to re-establish user-plane resources over 3GPPA in an allowed PDU session status IE to the network.

According to an embodiment, if the S-NSSAI of at least one PDU session of the n3GPPA is not supported in a current UE camped area over the 3GPPA, the processor 301 cannot indicate the at least one PDU session for which the UE is allowed to re-establish user-plane resources over 3GPPA in the allowed PDU session status IE to the network.

The processor 301 may include one or more processors. The one or more processors may be a general-purpose processor, such as a central processing unit (CPU), an application processor (AP), etc., a graphics-only processing unit such as a graphics processing unit (GPU), a visual processing unit (VPU), and/or an AI-dedicated processor such as a neural processing unit (NPU). The processor (110) may include multiple cores and is configured to execute the instructions stored in the memory 303.

Further, the processor 301 is configured to execute instructions stored in the memory 303 and to perform various processes. The communication module 302 is configured for communicating internally between internal hardware components and with external devices via one or more networks. The memory 303 also stores instructions to be executed by the processor 301. The memory 303 may include non-volatile storage elements. Examples of such non-volatile storage elements may include magnetic hard discs, optical discs, floppy discs, flash memories, or forms of electrically programmable memories (EPROM) or electrically erasable and programmable (EEPROM) memories. In addition, the memory 303 may, in some examples, be considered a non-transitory storage medium. The term “non-transitory” may indicate that the storage medium is not embodied in a carrier wave or a propagated signal. However, the term “non-transitory” should not be interpreted such that the memory 303 is non-movable. In certain examples, a non-transitory storage medium may store data that can, over time, change (e.g., in random access memory (RAM) or cache).

Although the FIG. 3 shows various hardware components of the UE 201, but it is to be understood that other embodiments are not limited thereon. In other embodiments, the UE 201 may include less or more number of components. Further, the labels or names of the components are used only for illustrative purposes and does not limit the scope of the embodiments disclosed herein. One or more components can be combined together to perform the same or substantially similar function in the UE 201.

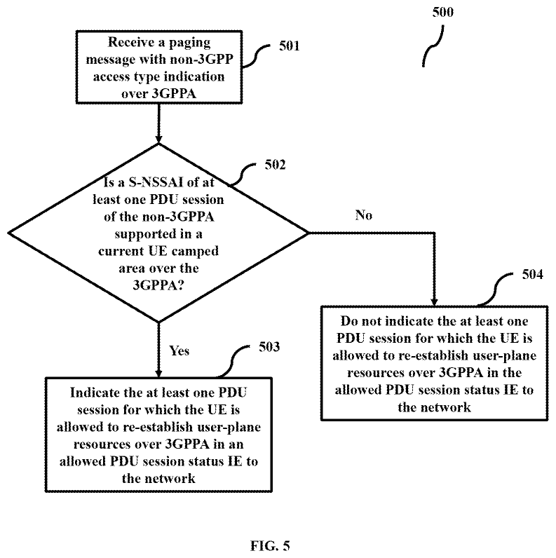

FIG. 4 is a diagram illustrating an NF, according to an embodiment. The NF 202A may include a processor 401, at least one communication module 402, and a memory 403. The NF 202A can manage paging resources in a wireless communication network. For example, the NF 202A may be an AMF. The processor 401 may check if a S-NSSAI of the PDU session for which there is pending downlink data is in the NSSAI list. The NSSAI list can be an allowed NSSAI list of 3GPP access or partially allowed NSSAI list of 3GPP access. The processor 401 may further page the UE 201 with n3GPPA type, if the PDU session for which downlink data is pending in the NSSAI list. If the PDU session for which downlink data is pending is not in the NSSAI list, the processor 401 may further indicate to a second NF 202B that the UE is not reachable. The UE 201 may be in an idle state over n3GPPA, and downlink data is pending in the NF 202A over the PDU session of n3GPPA type. If the PDU session for which downlink data is pending is not in the NSSAI list, the processor 401 cannot page the UE.

The second NF 202B may be at least one of an SMF; and an NF initiating a request to get the UE into connected mode.

The processor 401 may page the UE 201 with at least one of a n3GPPA type indication; and a notification message over 3GPPA with n3GPPA type indication.

The processor 401 may include one or more processors. The one or more processors may be a general-purpose processor, such as a CPU, an AP, or the like, a graphics-only processing unit such as a GPU, a VPU, and/or an AI-dedicated processor such as a NPU. The processor 401 may include multiple cores and is configured to execute the instructions stored in the memory 403.

Further, the processor 401 is configured to execute instructions stored in the memory 403 and to perform various processes. The communication module 402 is configured for communicating internally between internal hardware components and with external devices via one or more networks. The memory 403 also stores instructions to be executed by the processor 401. The memory 403 may include non-volatile storage elements. Examples of such non-volatile storage elements may include magnetic hard discs, optical discs, floppy discs, flash memories, or forms of EPROM or EEPROM memories. In addition, the memory 403 may, in some examples, be considered a non-transitory storage medium. The term “non-transitory” may indicate that the storage medium is not embodied in a carrier wave or a propagated signal. However, the term “non-transitory” should not be interpreted such that the memory 403 is non-movable. In certain examples, a non-transitory storage medium may store data that can, over time, change (e.g., in RAM or cache).

Although the FIG. 4 shows various hardware components of the NF 202A, but it is to be understood that other embodiments are not limited thereon. The NF 202A may include less or more number of components. Further, the labels or names of the components are used only for illustrative purposes and does not limit the scope of the embodiments disclosed herein. One or more components can be combined together to perform the same or substantially similar function in the NF 202A.

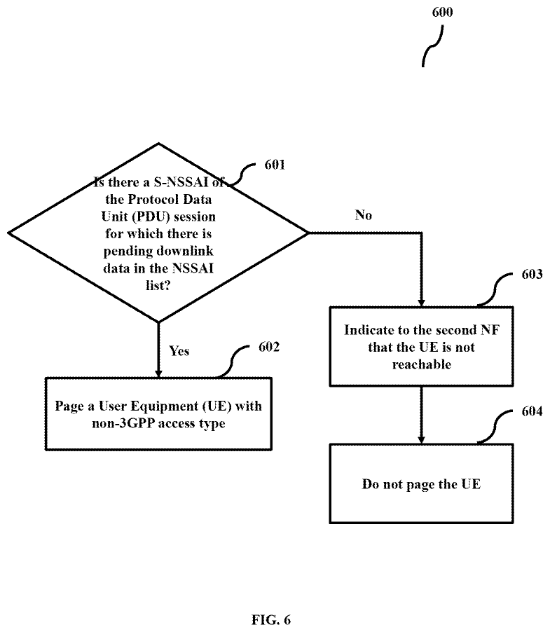

FIG. 5 is a flowchart illustrating the process of managing a PDU session in a wireless communication network, according to an embodiment. At 501, the UE 201 receives a paging message with n3GPPA type indication over 3GPPA. The UE has at least one PDU session with n3GPPA. At 502, the UE 201 determines if a S-NSSAI of at least one PDU session of the n3GPPA is supported in a current UE camped area over the 3GPPA. The UE 201 may determine that the S-NSSAI of at least one PDU session of the n3GPPA is supported in the current UE camped area over the 3GPPA based on partially allowed NSSAI, and NS-AoS information. The S-NSSAI of at least one PDU session of the n3GPPA supported in the current UE camped area over the 3GPPA is included in a partially allowed NSSAI for 3GPPA, and a TAI where the UE is currently camped is in the list of TAs for which the S-NSSAI is supported. The S-NSSAI of at least one PDU session of the n3GPPA supported in the current UE camped area over the 3GPPA is included in NS-AoS for 3GPPA, and the serving cell is in the list of cells for which the S-NSSAI is available. If the S-NSSAI of at least one PDU session of the n3GPPA is supported in a current UE camped area over the 3GPPA, at 503, the UE 201 indicates the at least one PDU session for which the UE is allowed to re-establish user-plane resources over 3GPPA in an allowed PDU session status IE to the network 202A. If the S-NSSAI of at least one PDU session of the n3GPPA is not supported in a current UE camped area over the 3GPPA, at 504, the UE 201 does not indicate the at least one PDU session for which the UE is allowed to re-establish user-plane resources over 3GPPA in the allowed PDU session status IE to the network. The various actions in method 500 may be performed in the order presented, in a different order or simultaneously. Further, in some embodiments, some actions listed in FIG. 5 may be omitted.

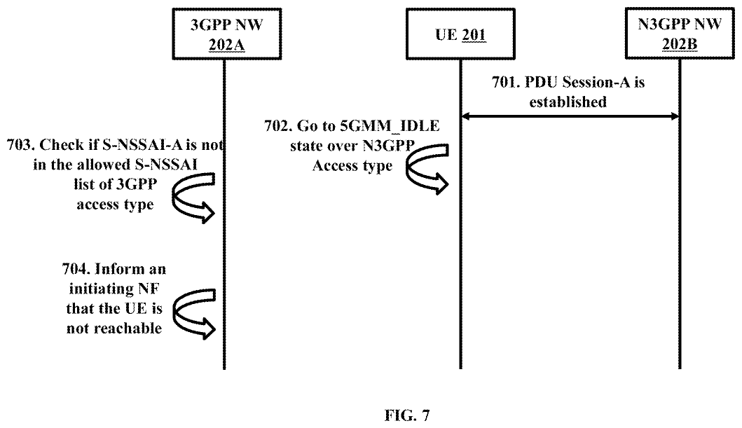

FIG. 6 is a flowchart illustrating a process of managing paging resources in a wireless communication network, according to an embodiment. The UE 201 may be in an idle state over n3GPPA, and downlink data may be pending over the PDU session of n3GPPA type. At 601, the NF 202A checks if a S-NSSAI of the PDU session for which there is pending downlink data is in the NSSAI list. If the PDU session for which downlink data is pending in the NSSAI list, at 602, the NF 202A pages a UE with n3GPPA type. The NF 202A may page the UE with at least one of a n3GPPA type indication; and a notification message over 3GPPA with n3GPPA type indication. If the PDU session for which downlink data is pending is not in the NSSAI list, at 603, the NF 202A indicates to the second NF 202B that the UE is not reachable. At 604, the NF 202A does not page the UE 201. The various actions in method 600 may be performed in the order presented, in a different order or simultaneously. Further, in some embodiments, some actions listed in FIG. 6 may be omitted.

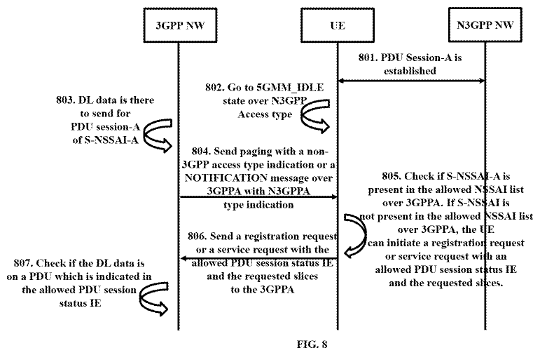

FIG. 7 is a flowchart illustrating a process for handling n3GPP slice registration in 3GPP networks, when paging is not allowed over access type having no allowed slice(s), according to an embodiment. The allowed NSSAI list may be as follows:
A. 3GPPA: S-NSSAI-B
B. N3GPPA: S-NSSAI-A, S-NSSAI-B

At 701, a PDU session is established over n3GPPA 202B having S-NSSAI-A. At 702, a UE goes to 5GMM_IDLE state over n3GPPA type. There may be DL data pending to be sent over the 3GPPA 202A for PDU session-A of S-NSSAI-A. At 703, the NF (e.g., the AMF) checks if S-NSSAI-A is not in the allowed NSSAI list of 3GPPA type. If S-NSSAI-A is not in the allowed NSSAI list of 3GPPA type, at 704, the 3GPPA 202A informs an initiating NF (that initiated the request to get UE into connected mode (such as, but not limited to, SMF)) that the UE 201 is not reachable (i.e., the network (i.e., NF such as, but not limited to, the AMF) 202A does not page the UE). In other words, the NF (e.g., AMF) notifies the initiating NF that reactivation of the user-plane resources for the corresponding PDU session(s) associated with n3GPPA cannot be performed. Otherwise, if S-NSSAI is part of allowed NSSAI list of 3GPPA type, then the network will page the UE 201 with one of a n3GPPA type indication or a NOTIFICATION message over 3GPPA with a n3GPPA type indication.

According to an embodiment, the NF (e.g., the AMF) checks if S-NSSAI-A is not in any of the rejected S-NSSAI lists, that are applicable for 3GPPA. If S-NSSAI-A is in the rejected S-NSSAI list, then the network (e.g., NF such as, but not limited to, the AMF) can choose to not page the UE 201 and notify the initiating NF that reactivation of the user-plane resources for the corresponding PDU session(s) associated with non-3GPP access cannot be performed. Otherwise, the 3GPPA 202A can page the UE 201 with a n3GPPA type indication or a notification message over 3GPPA with a n3GPPA type indication.

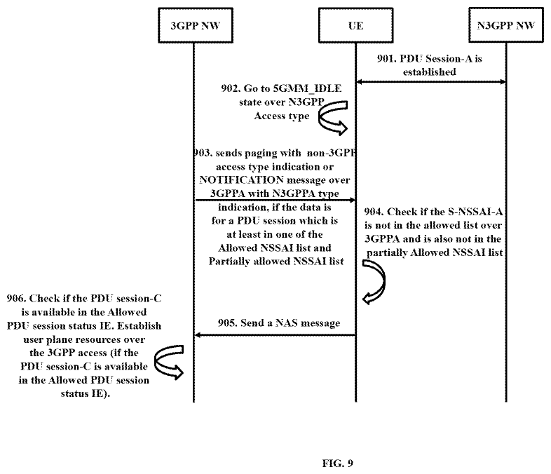

FIG. 8 is a flowchart illustrating a process for handling n3GPP slice registration in 3GPP networks, when paging with n3GPPA type indication is received, according to an embodiment. The UE may receive paging with n3GPPA type indication or a notification message over 3GPPA with n3GPPA type indication. At 801, the registration procedure is triggered in normal service sub-state in response to notification procedure or send service request message or any other NAS message.

The UE 201 may include allowed PDU session status IE along with the requested slice including all default configured NSSAI and configured NSSAI based on availability. Based on UE policy, the S-NSSAI are allowed to be registered on 3GPPA. For example, the S-NSSAI-A may not be in the allowed NSSAI list, optionally the S-NSSAI-A may not be in a rejected NSSAI list, but the S-NSSAI-A may be in a configured NSSAI list. The UE can include the S-NSSAI-A in a requested slice list in a registration request message.

The network 202A checks if DL data is on a PDU which is indicated in the allowed PDU session status IE. If the slice is not part of an allowed slice list, but is part of the requested slice list, the network 202A can check if that slice is allowed for the UE 201. If that slice is allowed for the UE 201, the network 202A can provide that slice in the allowed NSSAI list to the UE after executing network slice specific authentication and authorization (NSSAA) procedure (if required). For example, the network 202A checks if S-NSSAI-A is not already part of the allowed NSSAI list and provides S-NSSAI-A as an allowed NSSAI (if S-NSSAI-A is not already allowed). The network 202A may choose to only indicate S-NSSAI for a PDU session on which data was pending or all the S-NSSAI's UE has indicated in the requested slices list and allowed for the UE 201.

The network 202A moves the PDU session from n3GPPA 202B to 3GPPA 202A. The meaning of moving a PDU session from n3GPPA 202B to 3GPPA 202A is those respective PDU sessions user plane resources can be established in 3GPPA 202A; i.e., the UE 201 allows the user-plane resources to be re-established over 3GPPA.

The network 202A checks if the DL data is on a PDU session which is indicated in allowed PDU session status IE. The slice may not be part of the allowed NSSAI list, but the slice is part of the requested slice list. The network 202A can check if that slice is allowed for the UE 201. If that slice is not allowed for the UE 201, the network 202A can indicate to the UE 201 that the S-NSSAI was rejected with appropriate cause and the network 202A cannot initiate the establishment of the user plane resources over 3GPPA 202A. The network 201A can indicate the same to the initiating NF. The appropriate reject cause can be one of the below:
S-NSSAI not available in the current PLMN or SNPN,
S-NSSAI not available in the current registration arca,
S-NSSAI not available due to the failed or revoked network slice-specific authentication and authorization, and
S-NSSAI not available due to maximum number of UEs reached.

The rejected list may be maintained separately for each of the above reject causes and is referred to herein as a rejected slice list, or a rejected list.

The network 202A checks if no other PDU session of that slice is active in n3GPPA 202B, then the network 202A can release that slice implicitly in n3GPPA 202B. For example, S-NSSAI-A is removed from allowed NSSAI list ofnN3GPPA at the network 202A.

The UE 201 also removes it from the allowed NSSAI list of n3GPPA. S-NSSAI-A is removed from the allowed NSSAI list of n3GPPA at the UE 201.

The PIA is a PDU session id having S-NSSAI-A as a network slice.

The network 202A can page the UE 201 with n3GPPA type indication, if the UE 201 is in the idle state or notification message over 3GPPA with n3GPPA type, if the UE 201 is in the connected state.

The allowed S-NSSAI may be as follows:
3GPP Access: S-NSSAI-B
N3GPP Access: S-NSSAI-A, S-NSSAI-B

At 801, a PDU session-A may be established over N3GPP access 202B having S-NSSAI-A. At 802, the UE 201 may go to a 5GMM_IDLE state over n3GPPA type. At 803, the network 202A has DL data to send for PDU session-A of S-NSSAI-A. At 804, the network 202A may send a paging with n3GPPA type indication or notification message over 3GPPA with n3GPPA-type indication. At 805, the UE 201 can check if S-NSSAI is present/not present in the allowed NSSAI list over 3GPPA. If S-NSSAI is not present in the allowed NSSAI list over 3GPPA 202A, the UE 201 can initiate a registration request or service request with an allowed PDU session status IE and the requested slices. At 806, the UE 201 can send a registration request or a service request with the allowed PDU session status IE and the requested slices to the 3GPPA network 202A. At 807, the network 202A can check if the DL data is on a PDU which is indicated in the allowed PDU session status IE. If the S-NSSAI is not part of the allowed NSSAI list, the network 202A will check if that slice is allowed for the UE 201, and that slice is provided in the allowed NSSAI list to the UE. For example, the network 202A can check if S-NSSAI is not already allowed, and if S-NSSAI is not already allowed, the network 202A can provide S-NSSAI-A as an allowed NSSAI list, and the network 202A can move the PDU session from the N3GPPA 202B to the 3GPPA 202A.

FIG. 9 is a flowchart illustrating a process of establishing user plane resources over the 3GPP access, according to an embodiment. The allowed NSSAI list may be as follows:
A. 3GPPA: S-NSSAI-B
B. N3GPPA: S-NSSAI-A, S-NSSAI-B, S-NSSAI-C

The partially allowed NSSAI list may be as follows:
A. 3GPPA: S-NSSAI-C

At 901, a PDU Session-C is established over n3GPPA having S-NSSAI-C. At 902, the UE 201 goes to 9GMM_IDLE state over n3GPPA type. The NW 202A may have downlink data or mobile terminated data to send for PDU session-C of S-NSSAI-C. At 903, the NW 202A sends paging with n3GPPA type indication or notification message over 3GPPA with n3GPPA type indication. The network 202A can page the UE 201 only if the data is for a PDU session (which is at least in one of the allowed NSSAI list and partially allowed NSSAI list). If the data is not for a PDU session, the network 202A cannot page the UE 201, and indicates to the initiating NF that the paging has failed (as the UE is not reachable); i.e., the network 202A informs the initiating NF that the UE 201 is not reachable; i.e., the network 202A does not page the UE 201 or does not send notification over 3GPPA with n3GPPA type indication. At 904, the UE checks if the S-NSSAI-A is not in the allowed NSSAI list over 3GPPA and is also not in the partially allowed NSSAI list. If the S-NSSAI-A is not in the allowed list over 3GPPA and also not in the partially allowed NSSAI list, the UE 201 cannot indicate PDU session-A in the allowed PDU session status IE. The UE 201 includes any PDU session ID which is present in at least in one of the allowed NSSAI list and partially allowed NSSAI list in the allowed PDU session status IE. On 3GPP access, the UE 201 can check if the UE 201 is on the TAI which supports the S-NSSAI part of the partially allowed NSSAI list. If the UE 201 is on the supported TAI, then the UE 201 can include the PDU session IDs of the S-NSSAI which are part of the partially allowed NSSAI list. If the UE 201 is not on the supported TAI or the UE 201 is on the not supported TAI, then the UE 201 cannot include the PDU session IDs of the respective S-NSSAI in the allowed PDU session status IE. In step 905, the NAS message (such as, but not limited to, service request with allowed PDU session status IE) is sent to the network 202A. At 906, the network 202A checks if the PDU session-C is available in the allowed PDU session status IE. If the PDU session-C is available in the allowed PDU session status IE, the network 202A re-establishes user plane resources over the 3GPP access.

The allowed NSSAI list may be as follows:
A. 3GPPA: S-NSSAI-B
B. N3GPPA: S-NSSAI-A, S-NSSAI-B, S-NSSAI-C

The partially allowed NSSAI list may be as follows:
A. 3GPPA: S-NSSAI-C,
   TAI-1: Supported TAI, TAI-2 Not supported TAI.

When the UE 201 receives a paging with n3GPPA type or notification message over 3GPPA with n3GPPA type indication, the UE 201 can send a service request message with allowed PDU session status IE including the PDU session IDs of S-NSSAI-B and S-NSSAI-C in the allowed PDU session status IE. The UE 201 can include the PDU session IDs of S-NSSAI-C in the allowed PDU session status IE, if the UE 201 is on the TAI-1 (respective S-NSSAI supported TAI) over the 3GPP access. If the UE 201 is on the TAI-2 over 3GPPA (respective S-NSSAI NOT supported TAI), then the UE 201 cannot include the PDU session IDs of S-NSSAI-C in allowed PDU session status IE. The partially allowed NSSAI indicates the S-NSSAIs values that the UE 201 can use in the serving PLMN, or the SNPN in some of the TAs in the current registration area. Each S-NSSAI in the partially allowed NSSAI can be associated with a list of TAs where the S-NSSAI is supported.

When the UE 201 receives paging with n3GPAP access type, the UE can check, if on 3GPPA, the UE is on the TAI or the cell or any geographical area like CAG or by coordinates. The UE 201 determines the respective S-NSSAI that are supported in the area in 3GPP access, for example, using partially allowed NSSAI list or S-NSSAI location availability information or NS_AoS information or any other information. If the UE 201 is in (i.e., over, camped, or selected) the supported area (TAI/cell/CAG/geographical co-ordinate, NS_AoS etc. or any other measure of the area), then the UE 201 can include the PDU session IDs of the S-NSSAI which are supported in this area in the allowed PDU session status (i.e., if the UE 201 is not in the supported area or the UE is not in the supported area, then the UE 201 cannot include the PDU session IDs of the respective S-NSSAI in the allowed PDU session status IE).

The terms ‘allowed list’, and ‘allowed NSSAI list’ are used interchangeably herein and have the same meaning.

The terms ‘cell’, and ‘serving cell’ are used interchangeably herein and have the same meaning. Similarly, the terms ‘TAI’, and ‘serving TAI’ are used interchangeably herein and have the same meaning

The terms ‘camped area’ (TAI/cell/CAG/geographical co-ordinate, NS_AoS etc. or any other measure of the area), ‘selected area’ (TAI/cell/CAG/geographical co-ordinate, NS_AoS etc. or any other measure of the area) or ‘serving area’ (TAI/cell/CAG/geographical co-ordinate, NS_AoS etc. or any other measure of the area) are used interchangeably herein and have the same meaning.

The terms ‘S-NSSAI location availability information’, and ‘NS_AoS information’ are used interchangeably herein and have the same meaning.

The embodiments described herein can be implemented through at least one software program running on at least one hardware device and performing network management functions to control the network elements. The elements include blocks which can be at least one of a hardware device, or a combination of hardware device and software module.

The embodiments herein describe methods and systems for handling n3GPP slice registration in 3GPP networks. Therefore, it is understood that the scope of the protection is extended to such a program and in addition to a computer readable means having a message therein, such computer readable storage means contain program code means for implementation of one or more steps of the method, when the program runs on a server or mobile device or any suitable programmable device. The method is implemented in at least one embodiment through or together with a software program written in, for example, very high speed integrated circuit hardware description language (VHDL) another programming language, or implemented by one or more VHDL or several software modules being executed on at least one hardware device. The hardware device can be any kind of portable device that can be programmed. The device may also include means which could be, for example, hardware means such as an ASIC, or a combination of hardware and software means (e.g., an ASIC and an FPGA), or at least one microprocessor and at least one memory with software modules located therein. The method embodiments described herein could be implemented partly in hardware and partly in software. Alternatively, the invention may be implemented on different hardware devices (e.g., using a plurality of CPUs).

The foregoing description of the specific embodiments will so fully reveal the general nature of the embodiments herein that others can, by applying current knowledge, readily modify and/or adapt for various applications such specific embodiments without departing from the generic concept, and, therefore, such adaptations and modifications should and are intended to be comprehended within the meaning and range of equivalents of the disclosed embodiments. It is to be understood that the phraseology or terminology employed herein is for the purpose of description and not of limitation. Therefore, while the embodiments herein have been described in terms of embodiments and examples, those skilled in the art will recognize that the embodiments and examples disclosed herein can be practiced with modification within the scope of the embodiments as described herein.

While the disclosure has been shown and described with reference to certain embodiments therefor, it will be understood by those skilled in the art that various changes in form and detail may be made therein without departing from the scope of the disclosure. Therefore, the scope of the disclosure should not be defined as being limited to the embodiments, but should be defined by the appended claims and equivalents thereof.

What is claimed is:

1. A method performed by a terminal in a wireless communication system, the method comprising:
receiving, a paging message with an access type indicating non-third generation partnership (3GPP) access;
identifying whether the terminal has at least one protocol data unit (PDU) session associated with the non-3GPP access for which single network slice selection assistance information (S-NSSAI) associated with the at least one PDU session is included in partially allowed network slice selection assistance information (NSSAI) for 3GPP access; and
in case that the terminal has the at least one PDU session associated with the non-3GPP access for which the S-NSSAI associated with the at least one PDU session is included in the partially allowed NSSAI for the 3GPP access, transmitting, to an access and mobility management function (AMF), information indicating the at least one PDU session for which the terminal allows user-plane resources to be re-established over the 3GPP access.

2. The method of claim 1, further comprising:
in case that the terminal has the at least one PDU session associated with the non-3GPP access for which the S-NSSAI associated with the at least one PDU session is not included in the partially allowed NSSAI for the 3GPP access, determining not transmitting, to the AMF, the information indicating the at least one PDU session for which the terminal allows user-plane resources to be re-established over the 3GPP access.

3. The method of claim 1, wherein the transmitting, to the AMF, the information indicating the at least one PDU session for which the terminal allows the user-plane resources to be re-established over the 3GPP access comprises:
identifying whether a tracking area identity (TAI) where the terminal is currently camped is in a list of a tracking area (TA) for which the S-NSSAI is allowed; and
in case that the terminal has the at least one PDU session associated with the non-3GPP access for which the S-NSSAI associated with the at least one PDU session is included in the partially allowed NSSAI for the 3GPP access and the TAI where the terminal is currently camped is in the list of the TA for which the S-NSSAI is allowed, transmitting, to the AMF, the information indicating the at least one PDU session for which the terminal allows user-plane resources to be re-established over the 3GPP access.

4. The method of claim 1, wherein the information is included in an allowed PDU session status information element of a registration request message or a service request message.

5. A method performed by an access and mobility management function (AMF) in a wireless communication system, the method comprising:
identifying whether at least one protocol data unit (PDU) session associated with the non-3GPP access for which single network slice selection assistance information (S-NSSAI) associated with the at least one PDU session is included in allowed network slice selection assistance information (NSSAI) for 3GPP access; and
in case that the at least one PDU session associated with the non-3GPP access for which the S-NSSAI associated with the at least one PDU session is not included in the allowed NSSAI for the 3GPP access, transmitting, to a network function (NF), a message indicating that a terminal is not reachable.

6. The method of claim 5,
wherein the NF comprises a session management function (SMF), and
wherein, in case that the at least one PDU session associated with the non-3GPP access for which the S-NSSAI associated with the at least one PDU session is not included in the allowed NSSAI for the 3GPP access, paging to the terminal is not performed.

7. The method of claim 5, further comprising:
in case that the at least one PDU session associated with the non-3GPP access for which the S-NSSAI associated with the at least one PDU session is included in partially allowed NSSAI for the 3GPP access, receiving, from the terminal, the information indicating the at least one PDU session for which the terminal allows user-plane resources to be re-established over the 3GPP access.

8. A terminal in a wireless communication system, the terminal comprising:
a transceiver; and
at least one processor coupled with the transceiver and configured to:
receive, a paging message with an access type indicating non-third generation partnership (3GPP) access,
identify whether the terminal has at least one protocol data unit (PDU) session associated with the non-3GPP access for which single network slice selection assistance information (S-NSSAI) associated with the at least one PDU session is included in partially allowed network slice selection assistance information (NSSAI) for 3GPP access, and
in case that the terminal has the at least one PDU session associated with the non-3GPP access for which the S-NSSAI associated with the at least one PDU session is included in the partially allowed NSSAI for the 3GPP access, transmit, to an access and mobility management function (AMF), information indicating the at least one PDU session for which the terminal allows user-plane resources to be re-established over the 3GPP access.

9. The terminal of claim 8, wherein the at least one processor is configured to:
in case that the terminal has the at least one PDU session associated with the non-3GPP access for which the S-NSSAI associated with the at least one PDU session is not included in the partially allowed NSSAI for the 3GPP access, determine not transmitting, to the AMF, the information indicating the at least one PDU session for which the terminal allows user-plane resources to be re-established over the 3GPP access.

10. The terminal of claim 8, wherein the at least one processor is configured to:
identify whether a tracking area identity (TAI) where the terminal is currently camped is in a list of a tracking area (TA) for which the S-NSSAI is allowed, and
in case that the terminal has the at least one PDU session associated with the non-3GPP access for which the S-NSSAI associated with the at least one PDU session is included in the partially allowed NSSAI for the 3GPP access and the TAI where the terminal is currently camped is in the list of the TA for which the S-NSSAI is allowed, transmit, to the AMF, the information indicating the at least one PDU session for which the terminal allows user-plane resources to be re-established over the 3GPP access.

11. The terminal of claim 8, wherein the information is included in an allowed PDU session status information element of a registration request message or a service request message.

12. An access and mobility management function (AMF) in a wireless communication system, the AMF comprising:
a transceiver; and
at least one processor coupled with the transceiver and configured to:
identify whether at least one protocol data unit (PDU) session associated with the non-3GPP access for which single network slice selection assistance information (S-NSSAI) associated with the at least one PDU session is included in allowed network slice selection assistance information (NSSAI) for 3GPP access, and
in case that the at least one PDU session associated with the non-3GPP access for which the S-NSSAI associated with the at least one PDU session is not included in the allowed NSSAI for the 3GPP access, transmit, to a network function (NF), a message indicating that a terminal is not reachable.

13. The AMF of claim 12, wherein the NF comprises a session management function (SMF).

14. The AMF of claim 12, wherein, in case that the at least one PDU session associated with the non-3GPP access for which the S-NSSAI associated with the at least one PDU session is not included in the allowed NSSAI for the 3GPP access, paging to the terminal is not performed.

15. The AMF of claim 12, wherein the at least one processor is configured to:
in case that the at least one PDU session associated with the non-3GPP access for which the S-NSSAI associated with the at least one PDU session is included in partially allowed NSSAI for the 3GPP access, receive, from the terminal, the information indicating the at least one PDU session for which the terminal allows user-plane resources to be re-established over the 3GPP access.
